(19) United States
(12) Patent Application Publication
(10) Pub. No.: US 2025/0157085 A1
(43) Pub. Date: May 15, 2025

(54) METHOD AND APPARATUS FOR ENTROPY CODING IN DUAL DEGREE MESH CODING

(71) Applicant: TENCENT AMERICA LLC, Palo Alto, CA (US)

(72) Inventors: Thuong NGUYEN CANH, San Bruno, CA (US); Chao Huang, Palo Alto, CA (US); Xiaozhong Xu, State College, PA (US); Shan Liu, San Jose, CA (US)

(73) Assignee: TENCENT AMERICA LLC, Palo Alto, CA (US)

(21) Appl. No.: 18/936,399

(22) Filed: Nov. 4, 2024

Related U.S. Application Data
(60) Provisional application No. 63/598,098, filed on Nov. 11, 2023.
(60) Provisional application No. 63/598,096, filed on Nov. 11, 2023.

(51) Int. Cl. G06T 9/00

(52) U.S. Cl. CPC G06T 9/001

(57) ABSTRACT

A method includes generating a bitstream comprising an encoded three dimensional polygon mesh in accordance with dual degree connectivity comprising, when the polygon mesh comprises at least two different face degrees, a first sequence representing a vertex degree of each vertex in the polygon mesh, and a second sequence representing a face degree of each face in the polygon mesh, where each vertex degree in the first sequence and each face degree in the second sequence is followed by a degree offset, and at least one degree corresponding to a vertex degree in the first sequence or a face degree in the second sequence is encoded in accordance with a context adaptive binary arithmetic coding (CABAC) model that encodes the at least one degree using a difference between the at least one degree and a degree mode that indicates a number of different types of face degrees.

### CROSS-REFERENCE TO RELATED APPLICATION

This application claims priority from U.S. Provisional Application No. 63/598,098 filed on Nov. 11, 2023 and U.S. Provisional Application No. 63/598,096 filed on Nov. 11, 2023, the disclosures of each of which are incorporated herein by reference in their entirety.

### FIELD

This disclosure is directed to a set of advanced video coding technologies. More specifically, the present disclosure is directed to entropy encoding in dual degree mesh coding.

### BACKGROUND

The advances in 3D capture, modeling, and rendering have promoted the ubiquitous presence of 3D contents across several platforms and devices. Nowadays, it is possible to capture a baby's first step in one continent and allow the grandparents to see (and maybe interact) and enjoy a full immersive experience with the child in another continent. Nevertheless, in order to achieve such realism, models are becoming ever more sophisticated, and a significant amount of data is linked to the creation and consumption of those models. 3D meshes are widely used to represent such immersive contents.

A mesh is composed of several polygons that describe the surface of a volumetric object. Each polygon is defined by its vertices in 3D space and the information of how the vertices are connected, referred to as connectivity information. Optionally, vertex attributes, such as colors, normals, etc., could be associated with the mesh vertices. Attributes could also be associated with the surface of the mesh by exploiting mapping information that parameterizes the mesh with 2D attribute maps. Such mapping is usually described by a set of parametric coordinates, referred to as UV coordinates or texture coordinates, associated with the mesh vertices. 2D attribute maps are used to store high resolution attribute information such as texture, normals, displacements etc. Such information could be used for various purposes such as texture mapping and shading.

A dynamic mesh sequence may require a large amount of data since it may consist of a significant amount of information changing over time. Therefore, efficient compression technologies are required to store and transmit such contents. Mesh compression standards IC, MESHGRID, FAMC were previously developed by MPEG to address dynamic meshes with constant connectivity and time varying geometry and vertex attributes. However, these standards do not take into account time varying attribute maps and connectivity information. DCC (Digital Content Creation) tools usually generate such dynamic meshes. In counterpart, it is challenging for volumetric acquisition techniques to generate a constant connectivity dynamic mesh, especially under real time constraints. This type of contents is not supported by the existing standards. MPEG is planning to develop a new mesh compression standard to directly handle dynamic meshes with time varying connectivity information and optionally time varying attribute maps. This standard targets lossy, and lossless compression for various applications, such as real-time communications, storage, free viewpoint video, AR and VR. Functionalities such as random access and scalable/progressive coding are also considered.

Some encoding methods include dual degree encoding where face degrees and vertex degrees are encoded separately. However, this coding technique requires improved techniques to improve coding efficiency.

### SUMMARY

According to an aspect of the disclosure, a method performed by at least one processor includes generating a bitstream comprising an encoded three dimensional polygon mesh in accordance with dual degree connectivity comprising, when the polygon mesh comprises at least two different face degrees, a first sequence representing a vertex degree of each vertex in the polygon mesh, and a second sequence representing a face degree of each face in the polygon mesh, where each vertex degree in the first sequence and each face degree in the second sequence is followed by a degree offset, and where at least one degree corresponding to a vertex degree in the first sequence or a face degree in the second sequence is encoded in accordance with a context adaptive binary arithmetic coding (CABAC) model that encodes the at least one degree using a difference between the at least one degree and a degree mode that indicates a number of different types of face degrees.

According to an aspect of the disclosure, a method includes receiving a bitstream comprising an encoded three dimensional polygon mesh in accordance with dual degree connectivity comprising, when the polygon mesh comprises at least two different face degrees, a first sequence representing a vertex degree of each vertex in the polygon mesh, and a second sequence representing a face degree of each face in the polygon mesh, where each vertex degree in the first sequence and each face degree in the second sequence is followed by a degree offset, and where at least one degree corresponding to a vertex degree in the first sequence or a face degree in the second sequence is encoded in accordance with a context adaptive binary arithmetic coding (CABAC) model that encodes the at least one degree using a difference between the at least one degree and a degree mode that indicates a number of different types of face degrees.

According to an aspect of the disclosure, a method performed by at least one processor includes calculating, for a three dimensional polygon mesh, a degree of each face in the polygon mesh and a valence of each vertex; reducing, based on the calculating, a degree of at least one face in the polygon mesh via collapsing an edge of the at least one face; and reducing, based on the calculating, an edge valence of at least one vertex in the polygon mesh via merging a first face in the polygon mesh with a second face in the polygon mesh.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is an illustration of face degree and valence in dual degree coding, in accordance with embodiments of the present disclosure.

FIG. 4 is a flowchart of an example process for performing dual degree mesh simplification, in accordance with embodiments of the present disclosure.

FIGS. 5A and 5B illustrate an example of edge collapse, in accordance with embodiments of the present disclosure.

FIGS. 6A and 6B illustrate an example of face merging, in accordance with embodiments of the present disclosure.

FIG. 7 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

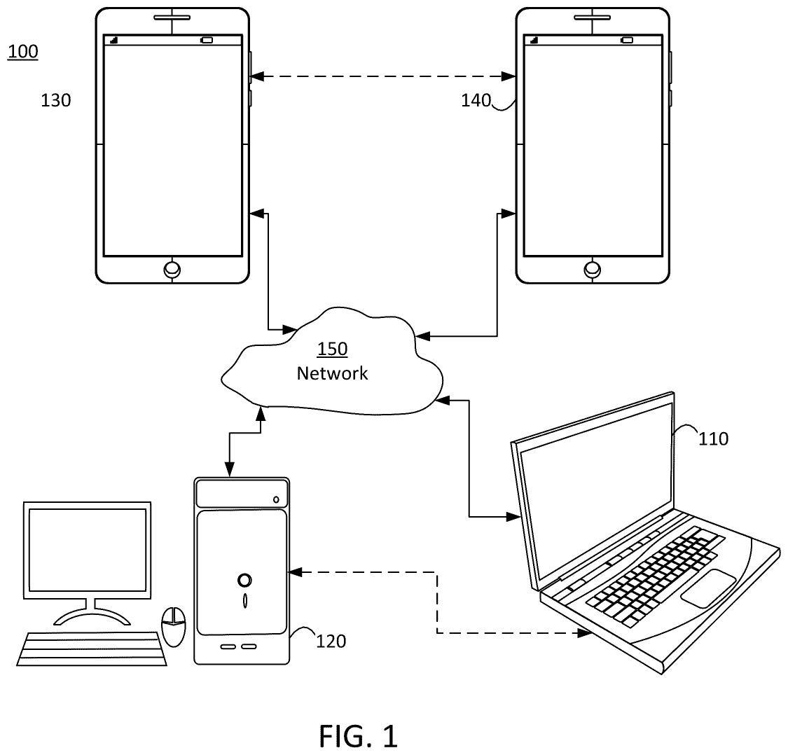

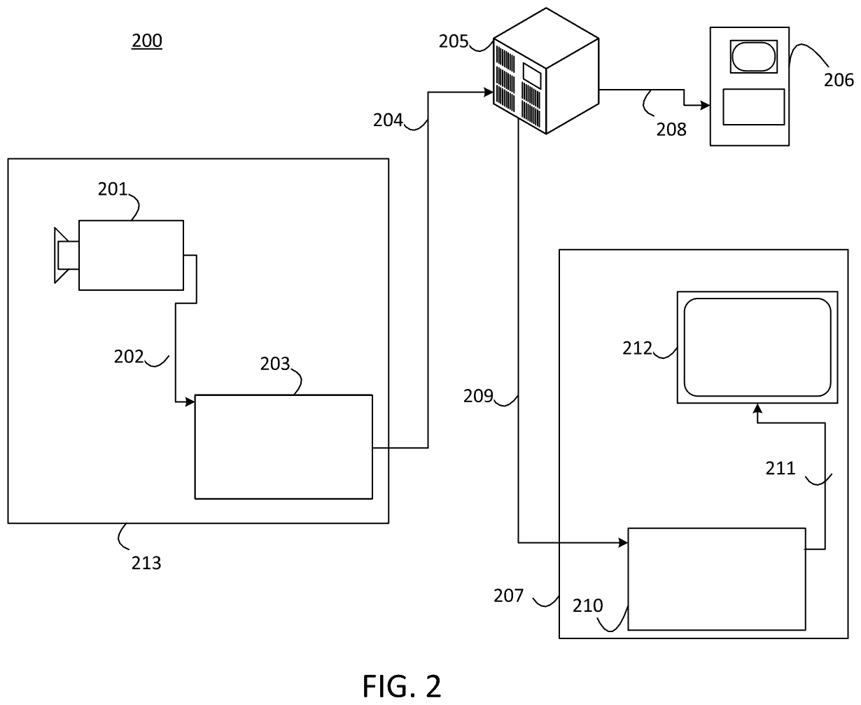

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

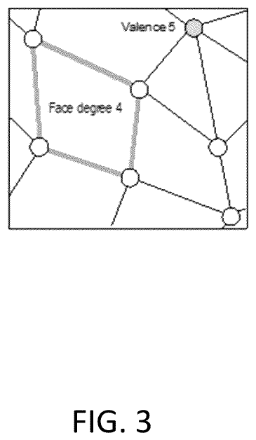

The Dual-Degree mesh coding is designed for the proficient encoding of the connectivity in polygon meshes. Utilizing the mathematical concept of duality, this method encodes connectivity information by forming two distinct sequences: one representing vertex degrees and the other representing face degrees (see FIG. 3). This method provides exceptional performance even in highly irregular, or worst-case, meshes. Dual degree coding performance is heavily dependent on the regularity of the face degree and vertex valence. Furthermore, a dummy face is often added to have close the boundary and efficient traversal. Accordingly, there needs to be a method to model efficient context for connectivity coding.

According to one or more embodiments, a face degree refers to a number of edges that enclose the face. For example, a face degree of 4 refers to a face enclosed by four faces. According to one or more embodiments, a vertex valence refers to a number of edges incident to a respective vertex.

Embodiments of the present disclosure directed to a method to simplify 3D mesh to reduce the variance in degree of the faces and valance of edges to favor dual degree connectivity coding while maintaining number of attributes.

The proposed methods may be used separately or combined in any order and may be used for arbitrary polygonal mesh.

According to one or more embodiments, statistical information of input faces, added dummy faces, and vertex degree are collected then used to signaling face and vertex degree sequentially. These staticical information include: dominance degree (d0), min (dmin) and max (dmax) degree as well as the degree of all attributes in degree_mtx.

In one or more examples, all face and vertex degree are encoded with Context Adaptive Binary Arithmetic Coding (CABAC). A common CABAC model is used sign, non-zero (with size of 2), and golomb code context (with size of 7). Signaling of given face degree is proceed as follow with degree_offset equal 3 for face degree and 2 for vertex degree. In one or more examples, the face degree is not signaled in single face degree mode. In one or more examples, the term degree mode may indicate a degree face type with the highest frequency. For example, a mesh with a triangle face (face degree 3) and a quadrilateral face (face degree 4), where the triangle face occurs with higher frequency than the quadrilateral face, has a degree mode of 3. In one or more examples, a mesh with a single face type (e.g., only triangle face or only quadrilateral face) may have a single degree mode.

Table 1 illustrate an example Encoder procedure.

TABLE 1

| | |
|---|---|
| degree_mode_minus_offset = degree_mode − degree_offset | u(b₀) |
| single_degree_flag = degree_max == degree_min | b(1) |
| if (not single_degree_flag) { | |
| for each curr_degree in degree_mtx { | |
| delta_degree = cur_degree − degree_mode | |
| CABAC(delta_degree, sign = true) | arith. |
| } | |
| } | |

Table 2 illustrates an example decoder procedure.

TABLE 2

```
degree_mode = degree_mode_minus_offset + degree_offset
single_degree_flag
if (not single_degree_flag) {
  for each curr_degree in degree_mtx {
    delta_degree = CABAC(bitstream, sign = true)
    curr_degree = degree_mode + delta_degree;
  }
}
```

According to one or more embodiments, a singledegreeag is set to false and not signaled for vertex degree as it is generally false in most cases.

According to one or more embodiments, context of CABAC is defined based on the current degree as follow for face and vertices.
1.

TABLE 3

```
Init Context with size of maxContext
for each curr_degree in degree_mtx {
  delta_degree = curr_degree − degree_mode
  ctxId = min(curr_degree − degree_offset, maxContext)
  ctx = Context[ctxId]
  CABAC(ctx, delta_degree, sign = true)
}
```

According to one or more embodiments, context of CABAC is defined based on both the current degree and the degree of a pivot vertex, which may be a vertex connected between at least two vertices. In one or more examples, a pivot vertex may refer to an encoded vertex in a mesh in which all the connectivity around that vertex is encoded or decoded.
For Face Degree:

TABLE 4

contextId = min(curr_degree − degree_offset, maxFaceContext)
context = faceContext[currPivotDegree][contextId]

For vertex degree:

TABLE 5

contextId = min(curr_degree − degree_offset, maxVertContext)
context = faceContext[currPivotDegree][contextId]

In one or more examples, the maxFaceContext may be a maximum value for the contextID for faces. In one or more exmaples, the maxVertContext may be a maximum value for the contextID for vertices.

According to one or more embodiments, the sign of delta_degree is derived the at decoder side while the degree_dominance is equal to degree_m or degreemax. Based on these configurations, the sign bit is saved for encoding all degree.

Table 6 illustrates an example encoder procedure.

TABLE 6

| | |
|---|---|
| degree_mode_minus_offset = degree_mode − degree_offset | u(b₀) |
| single_degree_flag = degree_max == degree_min | b(1) |
| if (not single_degree_flag) { | |
| degree_min_minus_mode = degree_mode − degree_min | u(b₁) |
| degree_max_minus_mode = degree_max − degree_mode | u(b₁) |
| needSign = degree_min_minus_mode && | |
| degree_max_minus_mode | |
| for each curr_degree in degree_mtx { | |
| if (!needSign) { | |
| delta_degree = abs(cur_degree − degree_mode) | |
| CABAC(delta_degree, sign = false) | arith. |
| } else { | |
| delta_degree = cur_degree − degree_mode | |
| CABAC(delta_degree, sign = true) | arith. |
| } | |
| } | |
| } | |

Table 7 illustrates an example decoder procedure.

TABLE 7

```
degree_mode = degree_mod_minus_offset + degree_offset
if (!single_degree_flag) {
  degree_min = degree_mode − degree_min_minus_mode
  degree_max = degree_max_minus_mod + degree_mode
  needSign = degree_min_minus_mode &&
  degree_max_minus_mode
  for each curr_degree in degree_mtx {
    if (!needSign) {
      delta_degree = CABAC(bitstream, sign = false)
      sign = (degree_mode == degree_min) ? +1 : −1;
      curr_degree = degree_mode + sign * delta_degree;
    } else {
      delta_degree = CABAC(bitstream, sign = true)
      curr_degree = degree_mode + delta_degree;
    }
  }
}
```

According to one or more embodiments, as an input mesh may be composed of multiple submeshes, their connectivity characteristic could be significantly different. For example, a mesh composed of a triangle and a quadriateral mesh are not a single_degree mesh, but per-submesh it is a single degree mesh. Therefore, the whole connectivity may be skipped.

According to one or more embodiments, the signaling of submesh statistics may be performed as follows.

TABLE 8

| | |
|---|---|
| most_degree_mode_minus_offset = most_degree_mode − | u(b₀) |
| degree_offset | |
| for each submesh in mesh in encoding order { | |
| degree_mode_minus = degree_mode − most_degree_mode | u(b₀) |
| ... same as in section 4.2 or 4.3 | |
| } | |

According to one or more embodiments, sub-meshes may be reordered/encoded in the order of increasing degree_mode. In this scenario, the difference between degree_mode between two consecutive submeshes may be encoded.

According to one or more embodiments, the attributes of a mesh include a vertex position, a texture coordinate, a normal vector, an associated texture map. For geometric attribute like vertex position, predictive coding scheme is often employed, for example, with parallelogram prediction. In terms of polygonal mesh, parallelogram prediction may perform the best with a quadrilateral mesh.

Mesh simplification is often required to simplify the representation of the mesh, thus reduce the encoding information for compression. Simplification could be done via decimation or remeshing. Decimation could be done via edge collapsing or face merging. However, decimation only aims to approximate the shape of the original mesh without concerning the regularity of face degree and vertex valance. On the other hand, previous remeshing method are struck on regularize the face and vertex degree, but failed to maintain the approximation quality the mesh at a reasonable number of attributes.

Dual degree mesh coding is heavily dependent on the regularity of the edge valence and face degree. Dual degree mesh coding also doesn't consider the attribute coding. Remeshing may only help for connectivity coding for dual degree mesh. Decimation may only help for reduce number of attribute but doesn't pay attention to regularity of edge valance and face degree.

The proposed methods may be used separately or combined in any order and may be used for arbitrary polygonal. In this disclosure, we propose a method to simplify input mesh to regularized edge valence and face degree while maintaining approximation quality to the original mesh. The embodiments are directed to a combination of face merging and edge collapsing.

As a high-degree face is surrounded by a low-valence of a vertex and vice versa, the embodiments reduce the high degree face and high valence vertex. This may be accomplished by alternating between reducing the highest degree faces then the highest valence vertex. The goal of the embodiments is to regularize the face degree to approximate to 4 as well as small variance of vertex valence and face degree.

The embodiments of the present disclosure, are directed to a method to simplify a 3D mesh to reduce the variance in degree of the faces and valance of edges to favor dual degree connectivity coding while maintaining number of attributes.

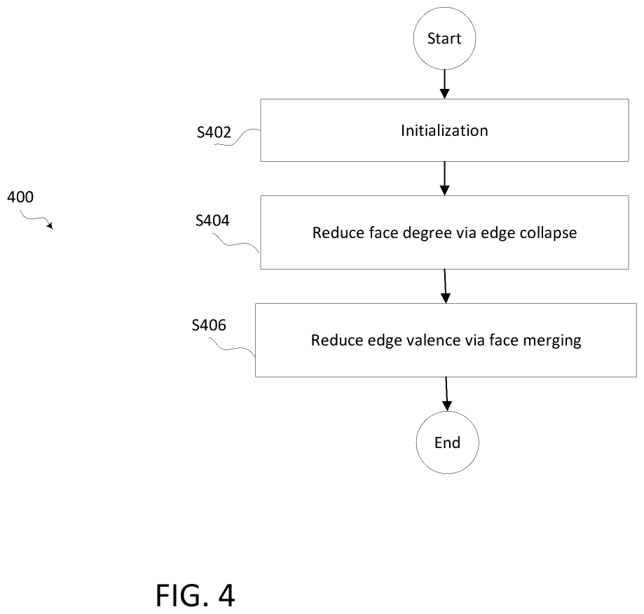

FIG. 4 illustrates a flow chart of an example process 400 for simplifying a 3D mesh. The process includes one or more of the following operations.

### Operation S402: Initialization

In one or more examples, in this operation, the degree of all faces and valence of all vertices is calculated. The faces and edges may be ordered in descending order of degree. Furthermore, a variance of face degree σ_{f} and vertex valance σᵥ may be calculated.

### Operation S404: Reduce Face Degree Via Edge Collapse

In one or more examples, for all the faces with highest degree fᵢ, the cost for collapsing it's edge is calculated and the minimum cost edge to be collapsed is selected. In one or more examples, a search is performed for a high degree face with a low valence vertex in its neighbor.

In one or more examples, the edge collapsing cost may be similar to a quadratic approximation error.

According to one or more embodiments, the cost of collapsing an edge may be the regularity of the neighbor face and vertex after adjustment. For example, the cost may be the variance of valence of neighbor vertex, and variance of neighbor faces.

Subsequently, the degree of the current face may be updated as dfᵢ=dfᵢ−1. For the collapsed vertex, for example, these two vertices may be collapsed to one (vₚ,v_{q})→vₖ. Then the degree of new vertex dvₖ=dv_{q}+dvₚ−2.

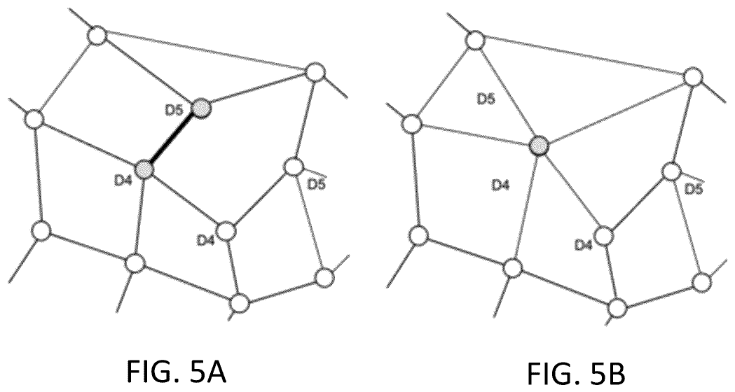

In case of maintaining the same number of vertices, new connectivity is introduced without modify the vertex. FIGS. 5A and 5B illustrate examples of edge collapse For example, FIG. 5A illustrates vertices D4 and D5, which are collapsed to D4, as illustrated in FIG. 5B.

### Operation S406: Reduce Edge Valence Via Face Merging

In one or more examples, for all edges with a highest valence vi, the cost for merging two of its neighbor faces is calculated and the minimum cost faces to be merged is selected. In one or more examples, the high valence vertex with small degree neighbor face is searched.

According to one or more embodiments, the cost of face merging is the quadratic approximation error.

According to one or more embodiments, the cost of face merging may be the regularity of the neighbor face and the vertex after adjustment.

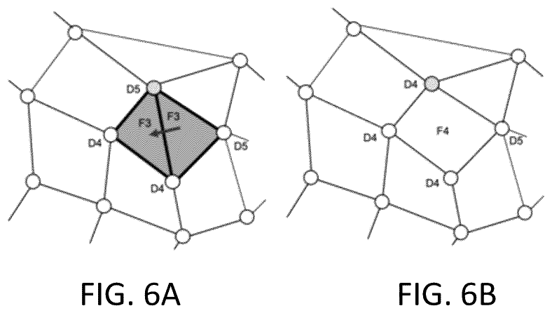

FIGS. 6A and 6B illustrate an example of face merging. For example, FIG. 6A illustrates faces F3 that are merged to face F4, as illustrated in FIG. 6B.

According to one or more embodiments, the process 400 is stopped if a number of targeted faces or vertexes is reached, or there is no change in the variance of face degree and vertex valence. Accordingly, the process operations 402, 404 and 406 may be repeated if the number of targeted faces or vertexes is not reached, and the variance of degree and vertex valence changes.

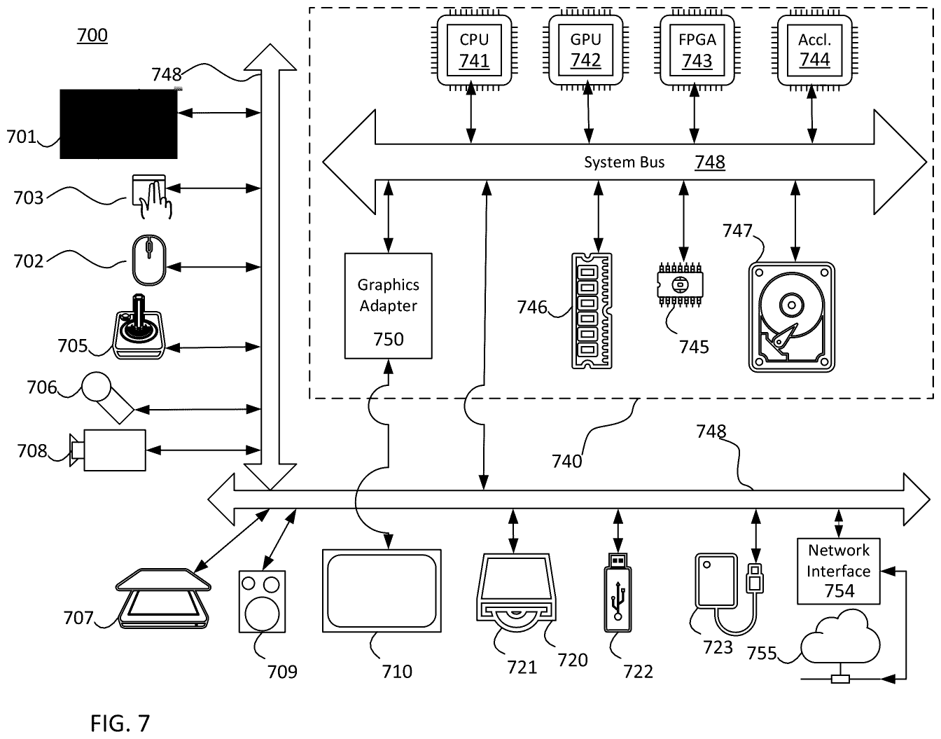

The techniques, described above, may be implemented as computer software using computer-readable instructions and physically stored in one or more computer-readable media. For example, FIG. 7 shows a computer system 700 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 7 for computer system 700 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, data-glove, joystick 705, microphone 706, scanner 707, camera 708.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, data glove, or joystick 705, but there may also be tactile feedback devices that do not serve as input devices). For example, such devices may be audio output devices (such as: speakers 709, headphones (not depicted)), visual output devices (such as screens 710 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 700 may also include human accessible storage devices and their associated media such as optical media including CD/DVD ROM/RW 720 with CD/DVD or the like media 721, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 749 (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks, computer system 700 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 755. Certain protocols and protocol stacks may be used on each of those networks and network interfaces as described above.

Aforementioned human interface devices, human-accessible storage devices, and network interfaces 754 may be attached to a core 740 of the computer system 700.

The core 740 may include one or more Central Processing Units (CPU) 741, Graphics Processing Units (GPU) 742, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 may be accessible in the form of one or more physical plugs to enable extensions by additional CPUs, GPU, and the like. The peripheral devices may be attached either directly to the core's system bus 748, or through a peripheral bus 749. Architectures for a peripheral bus include PCI, USB, and the like. A graphics adapter 750 may be included in the core 740.

CPUs 741, GPUs 742, FPGAs 743, and accelerators 744 may execute certain instructions that, in combination, may make up the aforementioned computer code. That computer code may be stored in ROM 745 or RAM 746. Transitional data may be also be stored in RAM 746, whereas permanent data may be stored for example, in the internal mass storage 747. Fast storage and retrieve to any of the memory devices may be enabled through the use of cache memory, that may be closely associated with one or more CPU 741, GPU 742, mass storage 747, ROM 745, RAM 746, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 700, and specifically the core 740 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 740 that are of non-transitory nature, such as core-internal mass storage 747 or ROM 745. The software implementing various embodiments of the present disclosure may be stored in such devices and executed by core 740. A computer-readable medium may include one or more memory devices or chips, according to particular needs. The software may cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system may provide functionality as a result of logic hardwired or otherwise embodied in a circuit (for example: accelerator 744), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method performed by at least one processor, the method comprising:
generating a bitstream comprising an encoded three dimensional polygon mesh in accordance with dual degree connectivity comprising, when the polygon mesh comprises at least two different face degrees, a first sequence representing a vertex degree of each vertex in the polygon mesh, and a second sequence representing a face degree of each face in the polygon mesh,
wherein each vertex degree in the first sequence and each face degree in the second sequence is followed by a degree offset, and
wherein at least one degree corresponding to a vertex degree in the first sequence or a face degree in the second sequence is encoded in accordance with a context adaptive binary arithmetic coding (CABAC) model that encodes the at least one degree using a difference between the at least one degree and a degree mode that indicates a number of different types of face degrees.

2. The method according to claim 1, wherein the bitstream comprises a degree minus offset parameter that is a difference between the degree mode and the degree offset.

3. The method according to claim 1, wherein the degree offset in the first sequence is a first degree offset and the degree offset in the second sequence is a second degree offset, wherein the first degree offset is different from the second degree offset.

4. The method according to claim 1, wherein the bitstream comprises a flag indicating that the degree mode is a single degree mode.

5. The method according to claim 1, wherein a model index is determined according to a minimum between (i) the difference between the at least one degree and the degree mode and (ii) a maximum index value, and wherein the CABAC model is selected based on the model index.

6. The method according to claim 1, wherein the bitstream further comprises (i) a degree minimum minus mode parameter that is a difference between the degree mode and a minimum face degree, and (ii) a degree maximum minus mode parameter that is a difference between a maximum face degree and the degree mode,
wherein a sign of the difference between the at least one degree and the degree mode is set to false when one of the degree minimum minus mode and the degree maximum minus mode parameter is false, and
wherein the sign of the difference between the at least one degree and the degree mode is set to true when both of the degree minimum minus mode and the degree maximum minus mode parameter are true.

7. The method according to claim 1, wherein the polygon mesh comprises a plurality of sub-meshes, wherein each sub-mesh that comprises at least two different face degrees comprises a respective first sequence representing a vertex degree of each vertex in a respective sub-mesh, and a second sequence representing a face degree of each face in the respective sub-mesh.

8. A method performed by at least one processor, the method comprising:
receiving a bitstream comprising an encoded three dimensional polygon mesh in accordance with dual degree connectivity comprising, when the polygon mesh comprises at least two different face degrees, a first sequence representing a vertex degree of each vertex in the polygon mesh, and a second sequence representing a face degree of each face in the polygon mesh,
wherein each vertex degree in the first sequence and each face degree in the second sequence is followed by a degree offset, and
wherein at least one degree corresponding to a vertex degree in the first sequence or a face degree in the second sequence is encoded in accordance with a context adaptive binary arithmetic coding (CABAC) model that encodes the at least one degree using a difference between the at least one degree and a degree mode that indicates a number of different types of face degrees.

9. The method according to claim 8, wherein the bitstream comprises a degree minus offset parameter that is a difference between the degree mode and the degree offset.

10. The method according to claim 8, wherein the degree offset in the first sequence is a first degree offset and the degree offset in the second sequence is a second degree offset, wherein the first degree offset is different from the second degree offset.

11. The method according to claim 8, wherein the bitstream comprises a flag indicating that the degree mode is a single degree mode.

12. The method according to claim 8, wherein a model index is determined according to a minimum between (i) the difference between the at least one degree and the degree mode and (ii) a maximum index value, and wherein the CABAC model is selected based on the model index.

13. The method according to claim 8, wherein the bitstream further comprises (i) a degree minimum minus mode parameter that is a difference between the degree mode and a minimum face degree, and (ii) a degree maximum minus mode parameter that is a difference between a maximum face degree and the degree mode,
wherein a sign of the difference between the at least one degree and the degree mode is set to false when one of the degree minimum minus mode and the degree maximum minus mode parameter is false, and
wherein the sign of the difference between the at least one degree and the degree mode is set to true when both of the degree minimum minus mode and the degree maximum minus mode parameter are true.

14. The method according to claim 8, wherein the polygon mesh comprises a plurality of sub-meshes, wherein each sub-mesh that comprises at least two different face degrees comprises a respective first sequence representing a vertex degree of each vertex in a respective sub-mesh, and a second sequence representing a face degree of each face in the respective sub-mesh.

15. A method performed by at least one processor, comprising:
calculating, for a three dimensional polygon mesh, a degree of each face in the polygon mesh and a valence of each vertex;
reducing, based on the calculating, a degree of at least one face in the polygon mesh via collapsing an edge of the at least one face; and
reducing, based on the calculating, an edge valence of at least one vertex in the polygon mesh via merging a first face in the polygon mesh with a second face in the polygon mesh.

16. The method according to claim 15, wherein the reducing the degree of the at least one face further comprises calculating a cost of each edge of the at least one face, wherein the edge of the at least one face that is collapsed has a minimum calculated cost.

17. The method according to claim 16, wherein the cost is calculated using a quadratic approximation error.

18. The method according to claim 15, wherein the reducing the edge valence of the at least one vertex further comprises calculating a cost of merging of each pair of neighbor faces of the at least one vertex wherein the first face and the second face is the pair of neighbor faces with a minimum calculated cost.

19. The method according to claim 18, wherein the cost is calculated using a quadratic approximation error.

20. The method according to claim 15, wherein the calculating, the reducing the degree of the at least one face, and the reducing the edge valence of the at least one vertex are repeated until a number of targeted faces or a number of targeted vertexes are reached.
